(19) United States
(12) Patent Application Publication
(10) Pub. No.: US 2026/0349629 A1
(43) Pub. Date: Nov. 5, 2026

(54) USER REGISTRATION SYSTEM AND USER REGISTRATION METHOD

(71) Applicant: BROTHER KOGYO KABUSHIKI KAISHA, Nagoya (JP)

(72) Inventor: Kazuki TSUJI, Nagoya (JP)

(21) Appl. No.: 19/451,697

(22) Filed: Jan. 16, 2026

(30) Foreign Application Priority Data
May 2, 2025 (JP) 2025-076980

(51) Int. Cl. G06F 3/12

(52) U.S. Cl. CPC G06F 3/1203; G06F 3/1231; G06F 3/1286; G06F 3/1287; G06F 3/129

(57) ABSTRACT

A system comprises a printer and a server. The printer is configured to cause a terminal device to display a first screen including printer identification information. The server is configured to receive a registration request including printer identification information, cause the terminal device to display a second screen for inputting user information, and store the user information and the printer identification information in an associated manner, thereby registering a user and the printer in an associated manner.

### REFERENCE TO RELATED APPLICATIONS

This application claims priority under 35 U.S.C. §119 from Japanese Patent Application No. 2025-076980 filed on May 2, 2025. The entire subject matter of the application is incorporated herein by reference.

### BACKGROUND ART

The present disclosure relates to a user registration system and a user registration method.

Conventionally, there is known an image forming system configured to perform registration of an account for identifying a user and device information of an image forming device for printing using a cloud print service.

Specifically, an administrator terminal displays, on a display, a service registration page stored in the image forming device and receives an input of an email address of a user to be registered. The administrator terminal transmits the input email address to the image forming device. The image forming device acquires device information required for registration from a device information storage, generates registration information based on the device information and the email address, and transmits the registration information to a cloud print service. The cloud print service, which has received the registration information, transmits a URL of a registration completion page to the image forming device. The image forming device transmits the URL to the email address of the user. When the user who has received the URL operates a user terminal to display the registration completion page and presses a registration completion button, registration of the image forming device with the cloud print service is completed.

### SUMMARY

According to aspects of the present disclosure, a system comprises a printer and a server. The printer is configured to transmit, to a terminal device, data of a first screen including an input element for a user inputting a registration instruction in response to a request from the terminal device, thereby causing a display of the terminal device to display the first screen, the data of the first screen including printer identification information identifying the printer and address information indicating a location of the server. The server is configured to, when the registration instruction is input to the first screen displayed on the display of the terminal device, receive a registration request transmitted from the terminal device to the server in accordance with the address information, the registration request including the printer identification information, in response to receiving the registration request, transmit, to the terminal device, data of a second screen including input elements for inputting user information, thereby causing the display of the terminal device to display the second screen, the second screen being a screen for registering, with the server, user information of a user that is not registered in association with the printer, and when the user information input to the second screen is received from the terminal device, store the user information and the printer identification information included in the registration request in an associated manner, thereby registering the user and the printer in an associated manner.

According to aspects of the present disclosure, a system comprises a printer and a server. The printer is configured to transmit, to a terminal device, data of a first screen including an input element for a user inputting a registration instruction in response to a request from the terminal device, thereby causing a display of the terminal device to display the first screen, the data of the first screen including address information indicating a location of the server, and transmit printer identification information identifying the printer to the server when transmitting the data of the first screen to the terminal device. The server is configured to, when the registration instruction is input to the first screen displayed on the display of the terminal device, receive a registration request transmitted from the terminal device to the server in accordance with the address information, in response to receiving the registration request, transmit, to the terminal device, data of a second screen including input elements for inputting user information, thereby causing the display of the terminal device to display the second screen, the second screen being a screen for registering, with the server, user information of a user that is not registered in association with the printer, and when the user information input to the second screen is received from the terminal device, store the user information and the printer identification information transmitted from the printer in an associated manner, thereby registering the user and the printer in an associated manner.

According to aspects of the present disclosure, a method for performing user registration using a printer and a server comprises transmitting, from the printer to a terminal device, data of a first screen including input elements for inputting a registration instruction in response to a request from the terminal device, thereby causing a display of the terminal device to display the first screen, the data of the first screen including printer identification information identifying the printer and address information indicating a location of the server, transmitting a registration request from the terminal device to the server in accordance with the address information when the registration instruction is input to the first screen displayed on the display of the terminal device, the registration request including the printer identification information, transmitting, from the server to the terminal device, data of a second screen including input elements for inputting user information in response to receiving the registration request, thereby causing the display of the terminal device to display the second screen, the second screen being a screen for registering, with the server, user information of a user that is not registered in association with the printer, transmitting, from the terminal device to the server, the user information input to the second screen, and storing, by the server, the user information and the printer identification information included in the registration request in an associated manner, thereby registering a user and the printer in an associated manner.

According to aspects of the present disclosure, a method for performing user registration using a printer and a server comprises transmitting, from the printer to the terminal device, data of a first screen including input elements for inputting a registration instruction in response to a request from a terminal device, thereby causing a display of the terminal device to display the first screen, the data of the first screen including address information indicating a location of the server, transmitting, from the printer to the server, the printer identification information when transmitting the data of the first screen to the terminal device, transmitting a registration request from the terminal device to the server in accordance with the address information, when the registration instruction is input to the first screen displayed on the display of the terminal device, transmitting, from the server to the terminal device, data of a second screen including input elements for inputting user information in response to receiving the registration request, thereby causing the display of the terminal device to display the second screen, the second screen being a screen for registering, with the server, user information of a user that is not registered in association with the printer, receiving, at the server, the user information input to the second screen from the terminal device, and storing, by the server, the user information and the printer identification information transmitted from the printer in an associated manner, thereby registering a user the printer in an associated manner.

The technology disclosed in the present specification can be implemented in various forms. For example, it can be implemented as a system including a terminal device, a printer, and a server, as the printer, as the server, as a method of performing user registration using the terminal device, the printer, and the server, as a computer program for realizing any of these systems, the printer, the server, or the method, or as a recording medium in which the computer program is recorded.

### BRIEF DESCRIPTION OF THE DRAWINGS

FIG. 1 is a block diagram illustrating a configuration of a system 1000.

FIG. 2 is an explanatory diagram of a database DBs.

FIG. 3 is a first sequence diagram of a service registration process.

FIG. 4 is a diagram showing an example of a management screen W1.

FIG. 5 is a diagram showing an example of a registration instruction screen W2.

FIG. 6 is a diagram showing an example of an input screen W3.

FIG. 7 is a diagram showing an example of a service registration screen W4.

FIG. 8 is a flowchart of processing after service registration.

FIG. 9 is a second sequence diagram of the service registration process.

FIG. 10 is a diagram showing an example of a login screen W5.

FIG. 11 is a diagram showing an example of a service registration screen W4.

FIG. 12 is an explanatory diagram of a database DBsC.

FIG. 13 is a sequence diagram of the service registration process.

FIG. 14 is a diagram showing an example of a login screen W5C.

FIG. 15 is a diagram showing an example of a service registration screen W4C.

FIG. 16 is a sequence diagram of the service registration process.

FIG. 17 is a flowchart of processing after service registration.

### DESCRIPTION

### A. Embodiment

### A1. Configuration of System 1000

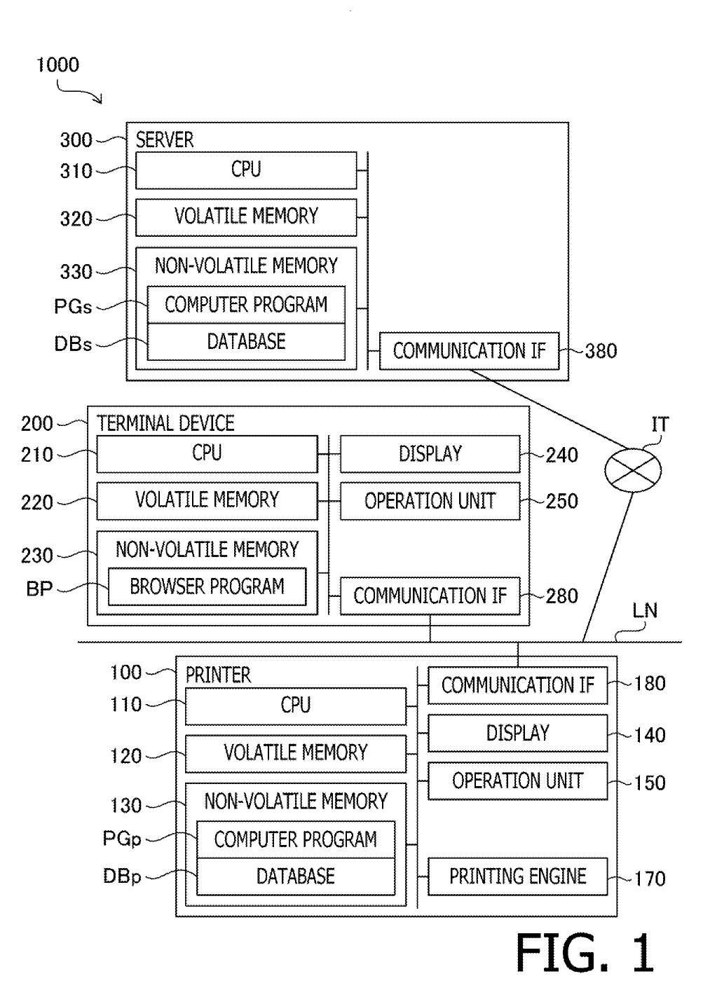

FIG. 1 is a block diagram illustrating a configuration of a system 1000. The system 1000 includes a printer 100, a terminal device 200, and, as will be described below, a server 300 for providing a service using the printer 100 (hereinafter simply referred to as “the service”).

The printer 100 is a device that performs printing by consuming ink as a printing material. The printer 100 includes, as a controller of the printer 100, a CPU 110, a volatile memory 120 such as DRAM, and a non-volatile memory 130 such as a hard disk or a flash memory. The printer 100 further includes a display 140 such as a liquid crystal display, an operation unit 150 such as buttons or a touch panel for acquiring operations from a user, a print engine 170, and a communication interface (IF) 180.

The communication IF 180 is an interface for connecting to the Internet IT, for example, a wired interface compliant with Ethernet (registered trademark) or a wireless interface compliant with the Wi-Fi standard.

The CPU 110 is a processor that performs data processes. The volatile memory 120 provides a buffer area for temporarily storing various intermediate data generated when the CPU 110 performs processes. The non-volatile memory 130 stores a computer program PGp for controlling the printer 100 and a database DBp.

In this embodiment, the computer program PGp is provided in a form stored in advance in the non-volatile memory 130 at the time of manufacture of the printer 100. Alternatively, the computer program PGp may be provided, for example, in a form downloaded from a server connected via the Internet IT, or in a form recorded on a recording medium such as a DVD ROM or a USB memory.

The CPU 110 performs the computer program PGp to execute various processes for controlling the printer 100. For example, the printer 100 (the CPU 110) controls the print engine 170 to print an image. In addition, by executing the computer program PGp, the printer 100 cooperates with the server 300 and the terminal device 200 to execute processes related to the service (e.g., a service registration process described below).

Various kinds of information related to the printer 100 are stored in the database DBp. The information stored in the database DBp includes, for example, identification information for identifying the printer 100 (a serial number in this embodiment), setting information related to printing, and setting information related to services provided by the server 300.

The print engine 170 executes printing under control of the CPU 110. In this embodiment, the print engine 170 is an inkjet printer engine configured to print an image on a recording medium using a plurality of types of ink, for example, four types of ink of cyan (C), magenta (M), yellow (Y), and black (K). Alternatively, the print engine 170 may be an electrophotographic print engine configured to print an image on a recording medium using toner contained in a toner cartridge as a colorant.

For example, the printer 100 is connected to a user’s local area network (LAN) LN and is used by the user.

The terminal device 200 is a computer used by a user of the printer 100, for example, a personal computer, and is connected to the local area network LN. In a modification of the embodiment, the terminal device 200 may be a smartphone or a tablet computer. The terminal device 200 includes a CPU 210 serving as a controller of the terminal device 200, a volatile memory 220 such as RAM, and a non-volatile memory 230 such as a hard disk drive or a flash memory.

Further, the terminal device 200 includes a display 240, an operation unit 250 configured to receive operations from a user, and a communication interface (IF) 280 that is a wired or wireless interface for connecting to the Internet IT. The display 240 is, for example, a liquid crystal display, and the operation unit 250 is a mouse, a keyboard, or a touch panel.

The CPU 210 is a processor that performs data processes. The volatile memory 220 provides a buffer area for temporarily storing various intermediate data generated when the CPU 210 performs processes. The non-volatile memory 230 stores a browser program BP.

The CPU 210 functions as a web browser by executing the browser program BP. The terminal device 200 (i.e., the CPU 210) functioning as the web browser cooperates with the server 300 to execute the service registration process described below. For example, the terminal device 200 is connected to the local area network LN and is connected to the Internet IT via the local area network LN.

The server 300 is a computer, such as a cloud server, operated by a provider that provides services (e.g., a provider that manufactures or sells the printer 100). The server 300 includes a CPU 310 serving as a controller of the server 300, a volatile memory 320 such as DRAM, a non-volatile memory 330 such as a hard disk or a flash memory, and a communication interface (IF) 380 that is a wired or wireless interface for connection to the Internet IT.

The CPU 310 is a processor that performs data processes. The volatile memory 320 provides a buffer area for temporarily storing various intermediate data generated when the CPU 310 performs processes. The non-volatile memory 330 stores a computer program PGs and a database DBs.

The computer program PGs is provided, for example, in a form uploaded by an operator of the server 300. The server 300 (the CPU 310) provides services by executing the computer program PGs. The server 300 also cooperates with the terminal device 200 to execute the service registration process described below. The database DBs stores various data necessary for processes related to the services (described later).

The server 300 is connected to the Internet IT. Accordingly, the server 300 can communicate with each of the printer 100 and the terminal device 200 via the Internet IT.

It is to be noted that, in FIG. 1, only the printer 100 is illustrated. However, the server 300 communicates with many devices (e.g., multifunction peripherals and stand-alone printers) and provides services using the devices (e.g., the printer 100). The following description explains processes related to the printer 100, but these processes can also be executed with other devices that are targets of the services.

The server 300 provides multiple types of services. For example, the services provided by the server 300 include various services using the printer 100, such as a printing material management service, an advertising distribution service, a remote printing service, and a content service.

The printing material management service is, for example, a service that manages a remaining amount of ink of the printer 100 and arranges a supply of ink according to the remaining amount. The advertising distribution service is a service that distributes advertisements to a user of the printer 100 by causing the printer 100, at a particular distribution timing (at a fixed time once per day in this embodiment) to print an image including one or more advertisement images.

The remote printing service is, for example, a service that causes the printer 100 to perform printing by generating a print job using an image file stored by a user in the server 300 or an image file transmitted from a user’s mobile terminal (not shown) and transmitting the print job to the printer 100. The content service is a service that downloads, to the printer 100, content data representing a content image and allows the content image to be used with the printer 100. The content image may include, for example, templates that include text fonts, characters from animations or comics, and patterns or designs for greeting cards (e.g., New Year’s cards or Christmas cards) and calendars.

In the following description, the server 300 will be described as providing four types of services 1-4. In this embodiment, in order to use these services, a user needs to perform user registration for each service to be used. In user registration for each service, a user and a device (e.g., the printer 100) are registered in association with each other. In this embodiment, duplicate registration of two or more users for one device (e.g., the printer 100) is not permitted. Registration of two or more services (e.g., the service 1 and the service 2) in association with one device is permitted.

### A2. Database DBs

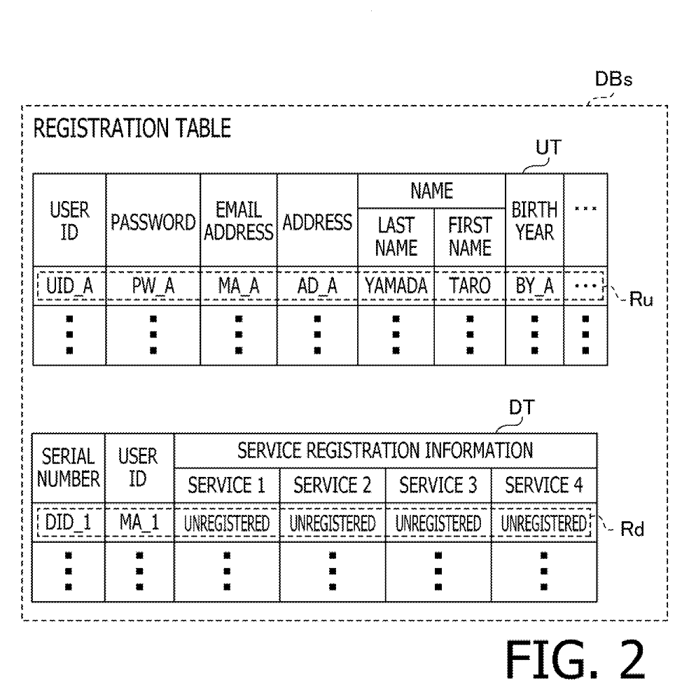

A database DBs stored in a non-volatile memory 330 of the server 300 will be explained below. FIG. 2 is an explanatory diagram of the database DBs. The database DBs shown in FIG. 2 includes a user table UT and a device table DT.

The user table UT is a table in which registered user information is stored. In this embodiment, the user table UT stores a user ID for identifying each of a plurality of registered users and a password of each user. In addition, in association with each user ID, various information of a user identified by the user ID is recorded. As shown in FIG. 2, the user information includes multiple items, specifically, a user ID, a password, an email address, an address, a user’s name, a birth year, and a gender. The user information further includes information necessary for use of the services, such as payment information (e.g., a credit card number) (not illustrated). In the example of FIG. 2, the above described user information is recorded in association with the user ID “UID_A” of the user.

The device table DT is a table in which information of devices (e.g., the printer 100) managed by the server 300 is stored. In this embodiment, serial numbers are stored in the device table DT as identification information of the plurality of devices managed by the server 300. Note that the identification information is not limited to a serial number, and any information unique to each device may be used, for example, a MAC address.

In the device table DT, a user ID and service registration information are further recorded in association with each serial number. The user ID is an identifier indicating a user registered in association with the device indicated by the serial number. The service registration information indicates, for each of the services 1-4 that can be used with the device indicated by the serial number, whether the service is registered as a use service. The use service is a service that is used with the device indicated by the corresponding serial number by the user indicated by the corresponding user ID.

In the device table DT of FIG. 2, in association with a serial number “DID_1” of the printer 100, a user ID “UID_A” indicating a user of the printer 100 is recorded. In addition, in the device table DT of FIG. 2, in association with a serial number “DID_A,” initial service registration information (service registration information indicating that all of the services 1-4 are unregistered) is recorded.

The database DBs stores various kinds of information for providing the services 1-4. For example, for the printing material management service, the database DBs stores a table for managing remaining amounts of ink in devices (e.g., printers and multifunction peripherals) used for the printing material management service, however, illustration and detailed description are omitted.

### A3. Service Registration Process

The service registration process targeting the above described services 1-4 will be explained. The service registration process registers, with the server 300, a service among the services 1-4 that a user wishes to use with the printer 100.

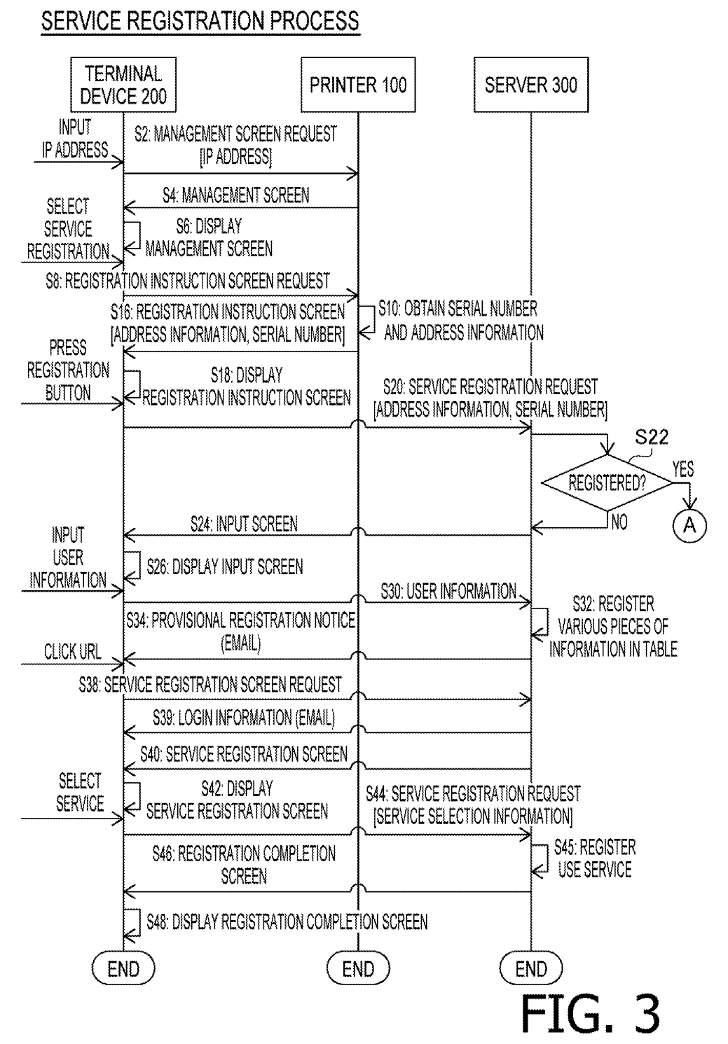

FIG. 3 is a first sequence diagram of the service registration process. When performing service registration in order to use a service, a user launches a browser program BP on the terminal device 200 and accesses the printer 100. For example, the user inputs, to the terminal device 200 functioning as a web browser, an IP address as destination information for accessing the printer 100.

Upon acquiring the IP address of the printer 100, the terminal device 200 functioning as the web browser (the CPU 210) transmits a management screen request to the printer 100 at S2. Communication between the terminal device 200 and the printer 100 is performed in accordance with a known protocol, for example, HTTP (Hypertext Transfer Protocol). Therefore, data transmitted from the terminal device 200 to the printer 100 are transmitted as an HTTP request, and data transmitted from the printer 100 to the terminal device 200 are transmitted as an HTTP response. For example, the management screen request is an HTTP request that includes the IP address of the printer 100 as destination information.

When the printer 100 (the CPU 110) receives the management screen request, the printer 100 transmits data of a particular management screen W1 to the terminal device 200 at S4. When the terminal device 200 receives the data of the management screen W1, the terminal device 200 displays the management screen W1 on a display 240 using the data at S6.

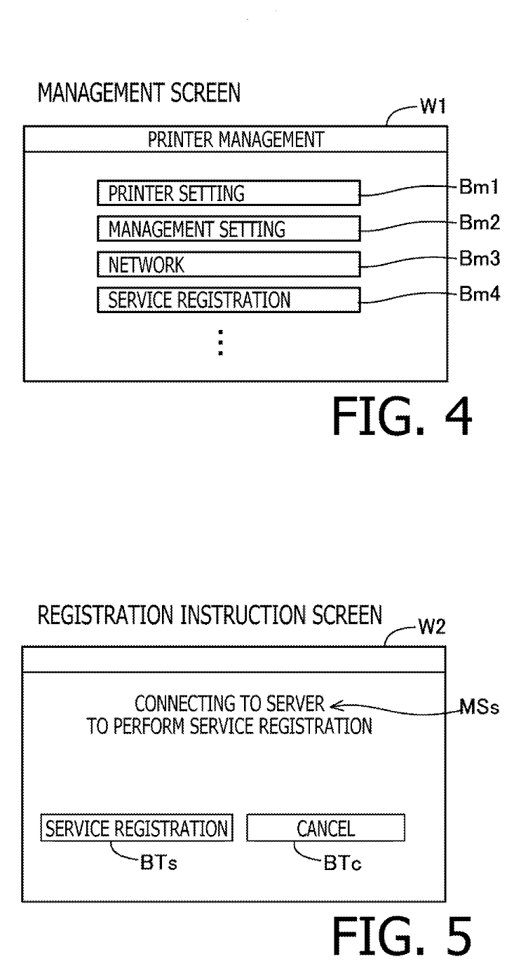

FIG. 4 illustrates an example of a management screen W1. The management screen W1 includes a plurality of selection buttons Bm1-Bm4. The selection buttons Bm1-Bm4 are input elements for a user to select a process to be executed as a management process of the printer 100. In this embodiment, the plurality of selectable management processes include, in addition to various settings of the printer 100 (e.g., settings related to printing, administrator, and network), a service registration process. In the example of FIG. 3, the user presses a selection button Bm4 for selecting the service registration process on the management screen W1, thereby inputting to the terminal device 200 an instruction to select the service registration process. When the instruction to select the service registration process is input to the terminal device 200, the terminal device 200 proceeds to S8. Description of processing when other selection buttons Bm1-Bm3 are pressed is omitted.

At S8, the terminal device 200 transmits a registration instruction screen request to the printer 100. When the printer 100 receives the registration instruction screen request, the printer 100 obtains a serial number of the printer 100 and address information of the server 300 from a database DBp at S10. The address information of the server 300 is information indicating a location of the server 300 on the Internet IT and is, specifically, a Uniform Resource Locator (URL).

At S16, the printer 100 transmits data of a registration instruction screen W2 to the terminal device 200. The data of the registration instruction screen W2 includes the above described serial number of the printer 100 and the address information (URL) of the server 300. For example, the serial number of the printer 100 is included in the data of the registration instruction screen W2 in a state where the serial number is associated with the URL of the server 300 as a query parameter.

When the terminal device 200 receives data of the registration instruction screen W2, the terminal device 200 displays the registration instruction screen W2 on the display 240 using the data at S18. FIG. 5 shows an example of the registration instruction screen W2. The registration instruction screen W2 includes a message MSs indicating that the terminal device 200 is to connect to the server 300 to perform service registration, and buttons BTs and BTc. A registration instruction button BTs is an input element for a user to input an instruction to register a service. A cancel button BTc is an input element for inputting an instruction not to perform the service registration. In the example of FIG. 3, the user presses the registration instruction button BTs to input to the terminal device 200 an instruction for the service registration. When the instruction for the service registration is input to the terminal device 200, the terminal device 200 proceeds to S20. When the cancel button BTc is pressed and an instruction not to perform the service registration is input, the terminal device 200 interrupts the service registration process (not shown in figures).

At S20, the terminal device 200 transmits, according to the address information (URL) of the server 300, a service registration request to the server 300. The service registration request includes the above described serial number of the printer 100 and the address information (URL) of the server 300. Specifically, in HTML data of the registration instruction screen W2, the registration instruction button BTs is associated with the URL of the server 300 to which the serial number of the printer 100 is associated as a query parameter. Therefore, when the registration instruction button BTs is pressed, an HTTP request including the URL as destination information is transmitted from the terminal device 200 to the server 300 as the service registration request.

When the server 300 (the CPU 310) receives the service registration request, the server 300 determines, at S22, whether a user’s device (also referred to as a target device; e.g., the printer 100) for which service registration is requested is registered. Specifically, the server 300 determines whether the serial number included in the service registration request is recorded in a device table DT (FIG. 2) stored in the database DBs. When the serial number is recorded in the device table DT, it is determined that the target device is registered, and when the serial number is not recorded in the device table DT, it is determined that the target device is unregistered.

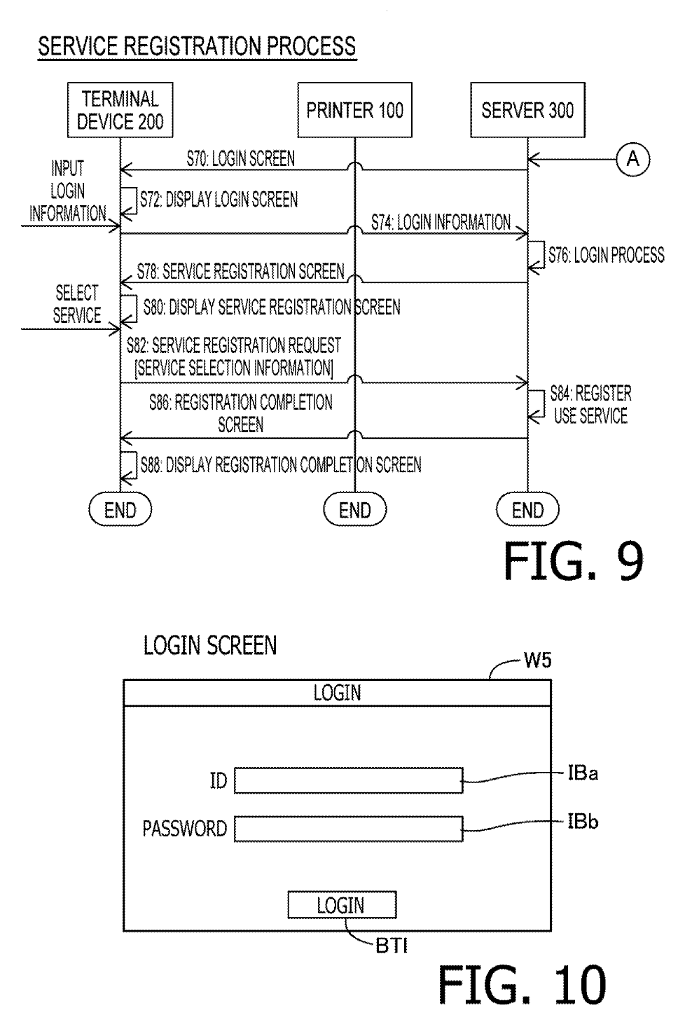

When a user of the printer 100 performs service registration for the first time, the printer 100 is unregistered. When the user performs service registration a second time, for example to add a use service, the printer 100 had been registered. When the printer 100, which is the target device, is unregistered (S22: NO), the server 300 proceeds to S24. When the printer 100, which is the target device, had been registered (S22: YES), the server 300 proceeds to S70 in FIG. 9, described later.

At S24, the server 300 transmits data of an input screen W3 to the terminal device 200. When the terminal device 200 receives the data of the input screen W3, the terminal device 200 displays the input screen W3 on a display 240 using the data at S26.

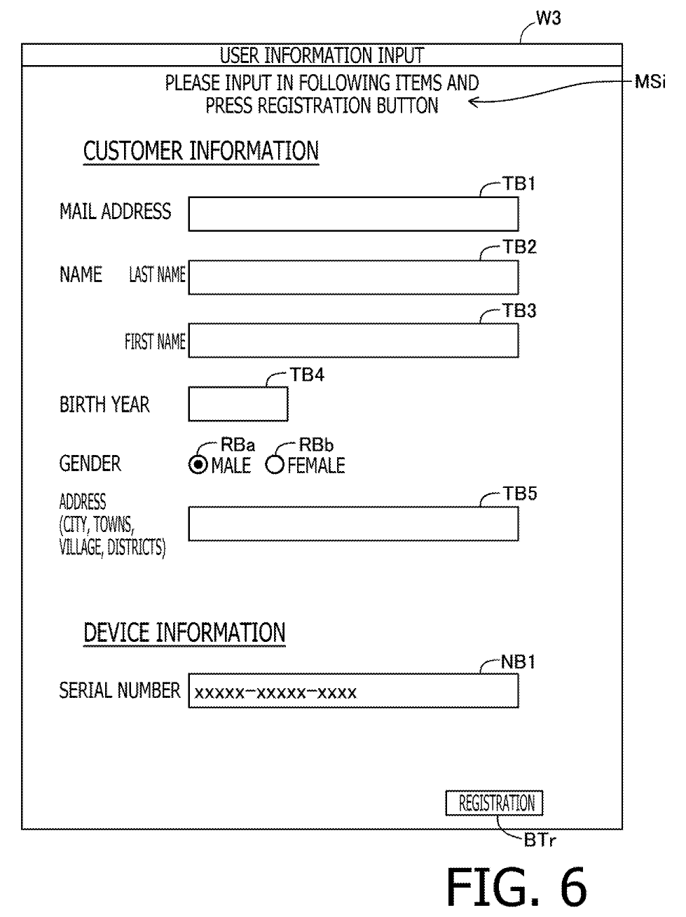

FIG. 6 illustrates an example of the input screen W3. The input screen W3 includes a message MSi that prompts user registration, a plurality of input elements TB1-TB5, RBa, and RBb, and a registration button BTr.

The plurality of input elements include input fields TB1-TB5 and radio buttons RBa and RBb for inputting respective items of user information to be registered. As described above, in this embodiment, the items to be registered include an email address, an address, a user’s name (surname and given name), a birth year, and a gender. These items include information containing personal information of the user and information relating to a device (e.g., the printer 100) used when the user uses a service. Note that the items shown in FIG. 6 are merely an example and other items may include, for example, items such as payment information (a credit card number), a telephone number, a display name, an occupation, and a job title may be included. In addition, the plurality of input elements of the input screen W3 may include items relating to the device other than a serial number, for example, a purchase month and year of the device and a store where the device was purchased.

Further, the input screen W3 includes a display field NB1 that displays a serial number. In the display field NB1, a serial number of the printer 100 is displayed. That is, in the display field NB1 of the input screen W3, the serial number is reflected at the time when the input screen W3 is displayed, and a user does not need to input the serial number. For example, the user can confirm, by checking the serial number displayed in the display field NB1, that the user’s own printer 100 is the target device in the service registration process.

The user inputs user information to be input in the plurality of input fields TB1-TB5, selects one of the radio buttons RBa and RBb according to the user’s gender, and then presses the registration button BTr. When the registration button BTr is pressed, the terminal device 200 acquires the user information input in the input screen W3.

At S30, the terminal device 200 transmits, to the server 300, the user information acquired via the input screen W3.

When the server 300 receives the user information from the terminal device 200, the server 300 registers various pieces of information in a database DBs (FIG. 2) at S32. Specifically, the server 300 generates a user ID and an initial password. The server 300 records user information such as a received email address, an address, and a name in a user table UT in association with the generated user ID and the initial password. As a result, in the user table UT of FIG. 2, one record (e.g., a record Ru indicated by a broken line in FIG. 2) is added. In addition, the server 300 records, in a device table DT, in association with a serial number received at S22 in FIG. 3, the generated user ID and initial service registration information. As a result, in the device table DT of FIG. 2, one record (e.g., a record Rd indicated by a broken line in FIG. 2) is added. The initial service registration information recorded at this time is information indicating that all of the services 1-4 are unregistered. Consequently, the printer 100, which is the target device, and a user of the printer 100 are registered in association with each other.

At S34, the server 300 transmits a provisional registration notice. In this embodiment, the provisional registration notice is transmitted in the form of an email addressed to an email address of the registered user. Thus, the provisional registration notice is transmitted, for example, via a mail server (not shown), to the user’s terminal device 200.

The provisional registration notice includes a particular URL indicating the server 300. The user launches an email client of the terminal device 200 to display the provisional registration notice (email) and clicks the URL included in the provisional registration notice.

When the URL included in the provisional registration notice is clicked, the terminal device 200 functioning as a web browser transmits a service registration screen request to the server 300 at S38. The service registration screen request is an HTTP request including the clicked URL as destination information. When the server 300 receives the service registration screen request within a particular period from transmission of the provisional registration notice, the server 300 proceeds to S39. In this case, registration of a user and a device performed at S32 is finalized. When the server 300 does not receive the service registration screen request within the particular period from transmission of the provisional registration notice, the server 300 invalidates the registration of the user and the device performed at S32 (not shown). For example, in this case, information recorded in a device table DT and a user table UT at S32 is deleted.

At S39, the server 300 transmits login information including the above described user ID and password. The login information is transmitted in the form of an email addressed to an email address of the user to whom the provisional registration notice was sent. Thus, the login information is transmitted, for example via a mail server (not shown), to the user’s terminal device 200. The login information is used during login described below.

At S40, the server 300 transmits data of a service registration screen W4 to the printer 100. The data of the service registration screen W4 are transmitted as an HTTP response to the service registration screen request. When the terminal device 200 receives the data of the service registration screen W4, the terminal device 200 displays, at S42, the service registration screen W4 on a display 240 using the data.

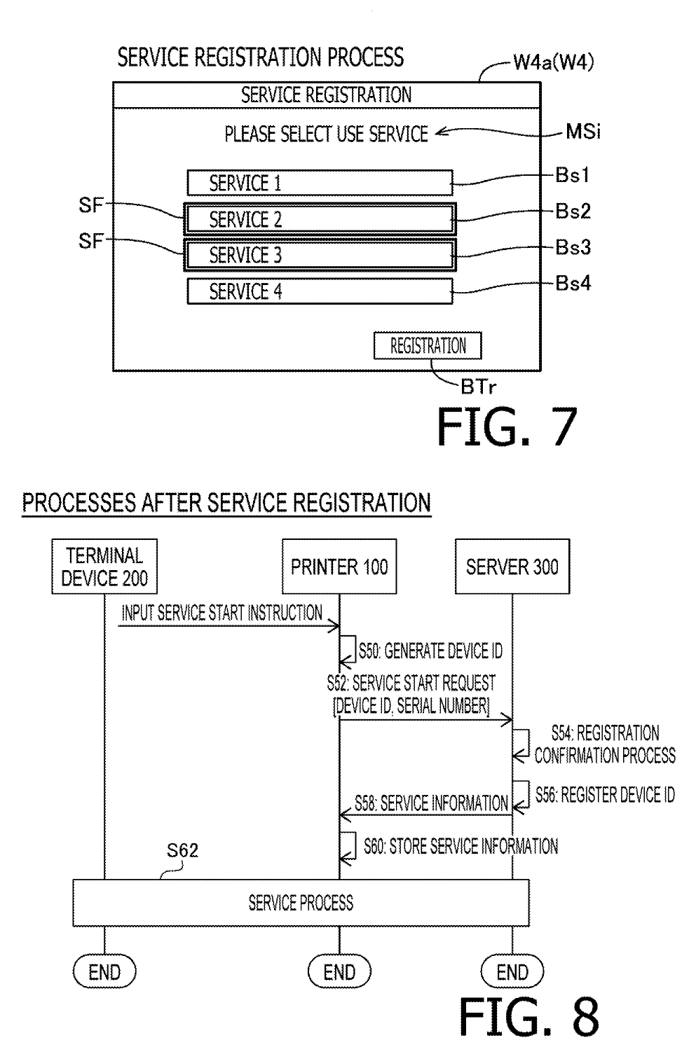

FIG. 7 illustrates an example of the service registration screen W4 of the embodiment. A service registration screen W4a in FIG. 7 includes a message MSi, a plurality of service selection buttons Bs1-Bs4, and a registration button BTr. The message MSi is a message that prompts a user to select a use service. The plurality of service selection buttons Bs1-Bs4 are input elements for inputting a selection instruction to select a use service.

For example, on the service registration screen W4, the user can select a use service by operating a service selection button corresponding to a service to be selected. In the example of FIG. 7, the services 2 and 3 corresponding to the service selection buttons Bs2 and Bs3 to which a selection frame SF is added are selected. The user presses the registration button BTr with one or more use services selected, thereby inputting, to the terminal device 200, a selection instruction for one or more use services.

When the terminal device 200 acquires the selection instruction of the use service, the terminal device 200 transmits a service registration request including service selection information to the server 300 at S44. The service selection information is information indicating the use service selected by the user’s selection instruction. When the server 300 receives the service registration request, the server 300 registers, at S45, the use service selected by the user according to the service selection information included in the service registration request. Specifically, the server 300 identifies, in the device table DT, a record Rd (FIG. 2) including the serial number of the printer 100. In the record Rd, the server 300 changes information of the use service indicated by the service selection information from “unregistered” to “registered.”

At S46, the server 300 transmits data of a registration completion screen to the terminal device 200. When the terminal device 200 receives the data of the registration completion screen, the terminal device 200 displays, at S48, the registration completion screen (not illustrated) on the display 240 using the data. The registration completion screen includes, for example, a message indicating that the use service selected by the user on the service registration screen W4 has been registered. When display of the registration completion screen is finished, the service registration process is completed.

Next, processes after the use service is registered by the service registration process will be described. FIG. 8 is a flowchart of the processes after service registration. For example, a case will be described in which, by the service registration process of FIG. 3, registration of a printing material management service is performed.

After the service registration process, a user operates the operation unit 150 of the printer 100 to input to the printer 100 a start instruction for a registered use service (e.g., the printing material management service). Note that the start instruction may be transmitted from the terminal device 200 to the printer 100. For example, similarly to S2-S4 of FIG. 3, the terminal device 200 functioning as a web browser may access a management screen of the printer 100 based on a user’s instruction and may transmit to the printer 100 the start instruction for the registered use service based on the user’s instruction with respect to the management screen. When the start instruction for the printing material management service is input, the printer 100 generates a device ID for a service at S50. The device ID for the service is identification information of the printer 100 different from a serial number and is identification information used only when the service is used. At S52, the printer 100 transmits, to the server 300, a service start request including the generated device ID and the serial number of the printer 100.

When the server 300 receives the service start request, the server 300 executes, at S54, a registration confirmation process. Specifically, the server 300 searches, in the device table DT, for a record Rd including the serial number included in the service start request, and, with reference to the record Rd, confirms whether a service that is the target of the service start request (e.g., the printing material management service) is registered as a use service.

When a service that is the target is unregistered, the server 300, for example, transmits an unregistered notification to the printer 100 and interrupts the processes of FIG. 8 (not illustrated). When the service that is the target is registered, the server 300 registers a device ID included in a service start request at S56. For example, the server 300 records the device ID, in association with a serial number included in the service start request, in a management table for the service (not illustrated).

At S58, the server 300 transmits, to the printer 100, service information necessary to provide a use service. For example, the service information includes information indicating a type of target information that the printer 100 should transmit to the server 300 and information indicating a timing at which the target information is to be transmitted to the server 300. For example, when the use service is a printing material management service, the service information includes information indicating that remaining amount information indicating remaining amounts of the printing material such as ink or toner is to be transmitted to the server 300 each time printing is executed, or information indicating that the remaining amount information is to be transmitted periodically to the server 300. Further, when a fee structure of the printing material management service is a usage-based fee structure according to a number of printed sheets, the service information may further include information indicating that print history information, such as the number of printed sheets, is to be transmitted to the server 300 periodically or each time printing is executed.

When the printer 100 receives the service information, the printer 100 stores the service information in the database DBp at S60. As a result, the printer 100 transitions to a state in which the printer 100 can transmit the target information to the server 300 in accordance with the service information. That is, thereafter, by transmitting the target information to the server 300 in accordance with the service information, the printer 100 cooperates with the server 300 and the terminal device 200 to execute a service process for providing the use service to a user (S62 of FIG. 8).

For example, when the use service is the printing material management service, the printer 100 transmits, at a particular transmission timing (e.g., at a periodic timing or at a timing when printing is executed), remaining amount information of the printing material to the server 300. The server 300 manages the remaining amounts of the printing material in the printer 100 by recording the remaining amount information transmitted from the printer 100 in a database DBs. When the remaining amount of the printing material in the printer 100 falls below a particular threshold, the server 300 executes a process (e.g., ordering to a vendor) to arrange for the printing material to be replenished to be sent to a user’s address for the printer 100. The server 300 also executes a payment process to settle fees for the printing material management service. The server 300 appropriately transmits notifications of a status of arrangement of the printing material and a status of settlement of the fees to the user’s terminal device 200 using, for example, email or another means.

Next, a case will be described in which a user who has registered one or more services to be used with the printer 100 additionally registers another service to be used with the printer 100. In the service registration process in this case, similarly to a case in which a use service is registered for the first time, a user launches a browser program BP on a terminal device 200 and inputs, to the terminal device 200 functioning as a web browser, an IP address of the printer 100 (FIG. 3).

When the IP address of the printer 100 is input to the terminal device 200, the processes of S2-S22 in FIG. 3 already explained are executed. In the service registration process for adding a use service, when the use service is registered, as described above, a user’s ID and a serial number of the printer 100 have already been registered in a device table DT (S32 of FIG. 3). Therefore, at S22, it is determined that the printer 100, which is the target device, is registered.

FIG. 9 is a second sequence diagram of the service registration process. When, at S22 of FIG. 3, the server 300 determines that the printer 100, which is the target device, is registered (S22: YES), the process proceeds to S70 of FIG. 9.

At S70, the server 300 transmits data of a login screen W5 to the terminal device 200. When the terminal device 200 receives the data of the login screen W5, the terminal device 200 displays, at S72, the login screen W5 on a display 240 using the data.

FIG. 10 illustrates an example of the login screen W5 of the first embodiment. The login screen W5 includes input fields IBa and IBb and a login button BTl. The input fields IBa and IBb are input elements for a user to input login information (e.g., a user ID and a password) for a login process. The user inputs, into the input fields IBa and IBb, the login information received by email at S39 of FIG. 3 and presses the login button BTl.

When the login button BTl is pressed, the terminal device 200 transmits the login information input on the login screen W5 to the server 300 at S74. When the server 300 receives the login information, the server 300 executes the login process using the login information at S76. In the login process, when the login information matches a user ID and a password registered in the user table UT, it is determined that login is successful, and when the login information does not match a user ID and a password registered in the user table UT, it is determined that login has failed. When it is determined in the login process that login is successful, the server 300 proceeds to S78. When it is determined in the login process that login has failed, the server 300 transmits, to the terminal device 200, a notification that login has failed and interrupts the service registration process (not illustrated).

At S78, the server 300 transmits data of a service registration screen W4 to the terminal device 200. When the terminal device 200 receives the data of the service registration screen W4, the terminal device 200 displays the service registration screen W4 on a display 240 using the data at S80.

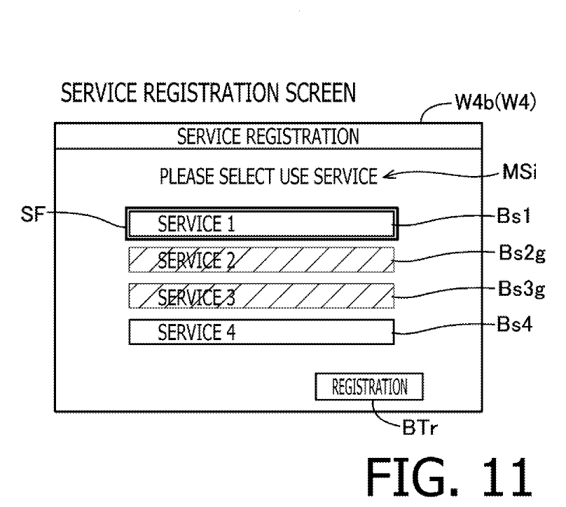

FIG. 11 illustrates an example of the service registration screen W4. A service registration screen W4b in FIG. 11 includes a message MSi, a plurality of service selection buttons Bs1, Bs2g, Bs3g, and Bs4, and a registration button BTr. The message MSi is a message prompting a user to select a use service. The plurality of service selection buttons Bs1, Bs2g, Bs3g, and Bs4 are input elements for inputting a selection instruction to select a use service from among multiple services 1-4.

At the time when the service registration screen W4 is displayed, the services 1-4 to be used with the printer 100 include a first type services that can be newly registered and a second type service that cannot be newly registered. For example, in this embodiment, services that are already registered as use services with the printer 100 cannot be registered again. Therefore, a service that is unregistered as use services at this time is the first type service, and a service that is already registered as use services at this time are the second type service.

The service registration screen W4b in FIG. 11 is a screen displayed when services 1 and 4 are the first type services and services 2 and 3 are the second type services. Unlike a service registration screen W4a (FIG. 7) displayed in a state where no use service is registered, the service registration screen W4b is configured such that the second type services that are already registered, namely services 2 and 3, cannot be selected by inputting a selection instruction.

For example, in this embodiment, on the service registration screen W4b, the service selection buttons Bs2g and Bs3g for inputting a selection instruction to select services 2 and 3 are grayed out. Even if a user presses the service selection buttons Bs2g and Bs3g, no selection frame SF is added to the buttons, and the user cannot select services 2 and 3. That is, in the example of FIG. 11, via the service registration screen W4b, the only selectable instructions are a selection instruction to select service 1, which is an unregistered service, and a selection instruction to select service 4, which is an unregistered service.

The user selects either the service 1 or the service 4 by pressing one of the service selection buttons Bs1 and Bs4 on the service registration screen W4b. In the example of FIG. 11, the service 1 corresponding to the service selection button Bs1 with a selection frame SF is selected. The user presses the registration button BTr with one or more selectable services selected, thereby inputting, to the terminal device 200, a selection instruction for one or more use services.

When the terminal device 200 acquires the selection instruction of the use service, the terminal device 200 transmits, at S82, a service registration request including service selection information indicating the selected use service to the server 300. When the server 300 receives the service registration request, the server 300 additionally registers, at S84, the use service selected by the user according to the service selection information included in the service registration request. Specifically, the server 300 identifies, in a device table DT, a record Rd (FIG. 2) including the serial number of the printer 100. In the record Rd, the server 300 changes information of the use service indicated by the service selection information from “unregistered” to “registered.”

At S86, the server 300 transmits data of a registration completion screen to the terminal device 200. When the terminal device 200 receives the data of the registration completion screen, the terminal device 200 displays, at S88, the registration completion screen (not illustrated) on the display 240 using the data. When display of the registration completion screen is finished, the service registration process ends. As a result, according to a selection instruction of a user, an additional use service is newly registered. When a new use service is registered, processes after the service registration (FIG. 8) are executed for the newly registered use service, and the service process of the newly registered use service is started.

According to the embodiment of the present disclosure, the printer 100 transmits, to the terminal device 200, data of the registration instruction screen W2 in response to a request from the terminal device 200 (S8 of FIG. 3) and causes the registration instruction screen W2 to be displayed on the display 240 of the terminal device 200 (S18 of FIG. 3). The data of the registration instruction screen W2 include a serial number for identifying the printer 100 and address information of the server 300. The server 300 receives, when a registration instruction is input to the registration instruction screen W2 displayed on the display 240 of the terminal device 200, a service registration request transmitted from the terminal device 200 to the server 300 according to the address information (S20 of FIG. 3). The service registration request includes the serial number of the printer 100. In response to receiving the service registration request (S20 of FIG. 3), the server 300 transmits data of an input screen W3 to the terminal device 200 (S24 of FIG. 3) and causes the input screen W3 to be displayed on the display 240 of the terminal device 200 (S26 of FIG. 3).

When user information is input to the input screen W3 displayed on the display 240 of the terminal device 200 and received from the terminal device 200 (S30 of FIG. 3), the server 300 stores, in association, the user information and the serial number (S32 of FIG. 3, records Ru and Rd of FIG. 2), thereby registering a user and the printer 100 in association with each other. As a result, the server registers a user and a printer in association with each other. In addition, since the serial number of the printer 100 is included in the data of the registration instruction screen W2 transmitted from the printer 100 to the terminal device 200 and is included in the service registration request transmitted from the terminal device 200 to the server 300, a user does not need to input the serial number of the printer 100 to the terminal device 200. Accordingly, a burden on the user in the service registration process can be reduced. A serial number may have a large number of digits, and if a user inputs the serial number, an input error might occur and the service registration process might not proceed promptly. According to this embodiment, such a problem can be suppressed.

Further, according to this embodiment, when the server 300 receives the service registration request (S20 of FIG. 3), the server 300 determines, based on the serial number, whether the printer 100 is registered or unregistered (S22 of FIG. 3). When it is determined that the printer 100 is registered (YES at S22 of FIG. 3), the server 300 transmits data of a login screen W5 to the terminal device 200 in response to receiving the service registration request (S70 of FIG. 9) and causes the login screen W5 to be displayed on the display 240 of the terminal device 200 (S72 of FIG. 9). When it is determined that the printer 100 is unregistered (NO at S22 of FIG. 3), the server 300 transmits data of the input screen W3 to the terminal device 200 in response to receiving the service registration request (S24 of FIG. 3). As a result, without requiring a user to input the serial number of the printer 100 into the terminal device 200, an appropriate screen (the input screen W3 or the login screen W5) can be displayed on the display 240 of the terminal device 200 according to whether the printer 100 is registered or unregistered.

Further, according to this embodiment, after a user and the printer 100 are registered (S32 of FIG. 3), the server 300 transmits data of the service registration screen W4 to the terminal device 200 (S40 of FIG. 3) and thereby causes the service registration screen W4 to be displayed on the display 240 of the terminal device 200 (S42 of FIG. 3). When the server 300 receives, from the terminal device 200 (S44 of FIG. 3), information indicating a use service selected by a selection instruction input to the service registration screen W4, the server 300 registers the use service by storing information of the selected use service in association with the user ID and the serial number (S45 of FIG. 3). As a result, after the user and the printer 100 are registered in association with each other, a service to be used by the user can be registered.

Further, according to this embodiment, at the time when the service registration screen W4 is displayed, the multiple services 1-4 include the first type service that can be newly registered and the second type service that cannot be newly registered. The service registration screen W4b is configured such that, as the selection instruction, an instruction to select the first type service can be input, and an instruction to select the second type service cannot be input (FIG. 11). Consequently, the service registration screen that allows the user to input an appropriate selection instruction can be displayed on the terminal device 200. For example, it is possible to suppress an inconvenience in which the user mistakenly inputs an instruction to register an unregistrable service as a use service.

Specifically, in this embodiment, the first type service that is registrable includes a service that is unregistered as use services. As a result, for example, a selection instruction to select an unregistered service as a use service can be input to the service registration screen W4b. Therefore, the user can be allowed to register and use an unregistered service as a use service.

In this embodiment, the second type service that are unregistrable include services that are already registered as use services. Consequently, it is possible to suppress an inconvenience in which the user mistakenly inputs an instruction to register a service that is already registered as a use service.

Further, in this embodiment, the input screen W3 includes the display field NB1 for inputting a serial number that is printer identification information. As a result, for example, although the user need not input the serial number, by seeing the user’s own serial number displayed on the input screen W3, the user can confirm that the registration process relates to the user’s own printer 100.

Further, in this embodiment, after service registration, the printer 100 transmits to the server 300 a start request for a use service (S52 of FIG. 8). In response to receiving the start request, the server 300 transmits, to the printer 100, a response including service information (S58 of FIG. 8), thereby causing the printer 100 to transition to a state in which communication for a particular service with the server 300 can be performed. For example, the printer 100 transitions to a state in which target information such as an ink remaining amount can be transmitted to the server 300 at a particular timing. Consequently, the system 1000 can provide, to the user, the service selected by the user.

As is apparent from the above description, the registration instruction screen W2 of this embodiment is an example of a first screen, and the input screen W3 is an example of a second screen. A login screen W5 of this embodiment is an example of a third screen, and the service registration screen W4 is an example of a fourth screen. A serial number of this embodiment is an example of printer identification information.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the application, and not limiting the application. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described embodiment are provided below.

### B. Modification of Embodiment

A modification of the embodiment according to aspects of the present disclosure which will explained below differs from the embodiment explained above in that multiple users can be registered in association with one device, for example, the printer 100. Therefore, in the modification embodiment, information stored in a database of the server 300 differs from that of the embodiment explained above (FIG. 2).

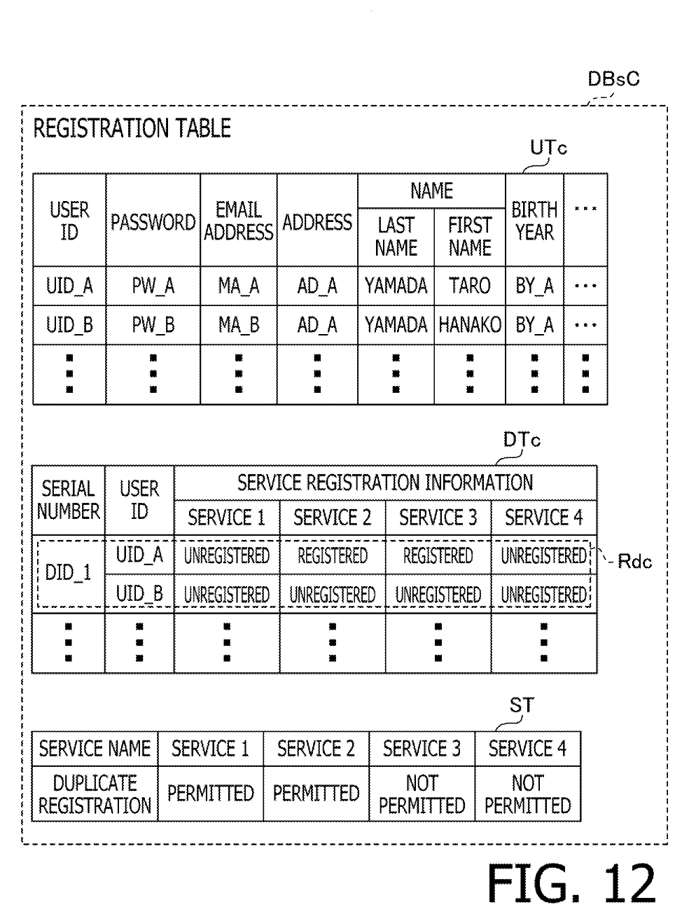

FIG. 12 is an explanatory diagram of a database DBsC. The database DBsC of FIG. 12 includes a user table UTc, a device table DTc, and a service attribute table ST.

The user table UTc is, similarly to the user table UT of FIG. 2, a table in which registered user information is stored. In the example of FIG. 12, with respect to two users associated with the printer 100, user information according to the first embodiment is recorded in association with user IDs “UID_A” and “UID_B.” Multiple users associated with one printer 100 may include, for example, family members living together or employees in the same workplace.

The device table DTc, similarly to the device table DT of FIG. 2, is a table in which information of devices (e.g., the printer 100) managed by the server 300 is stored. In the device table DTc of FIG. 12, it is permitted to record, in association with a single serial number of the printer 100, multiple user IDs. In the example of FIG. 12, two user IDs “UID_A” and “UID_B” are associated with a serial number “DID_1” of the printer 100. In the device table DTc, service registration information similar to that of the first embodiment is recorded for each user ID. Accordingly, multiple users can be registered in association with one device, and a registration status of the use service is managed for each user.

The service attribute table ST records, for each of multiple available services, whether duplicate registration is permitted. In the example of FIG. 12, among the services 1-4, duplicate registration is permitted for the services 1 and 2, and duplicate registration is not permitted for the services 3 and 4. A service for which duplicate registration is permitted may be registered in association with each of multiple users of the printer 100. A service for which duplicate registration is not permitted is registered in association with only one of the multiple users of the printer 100.

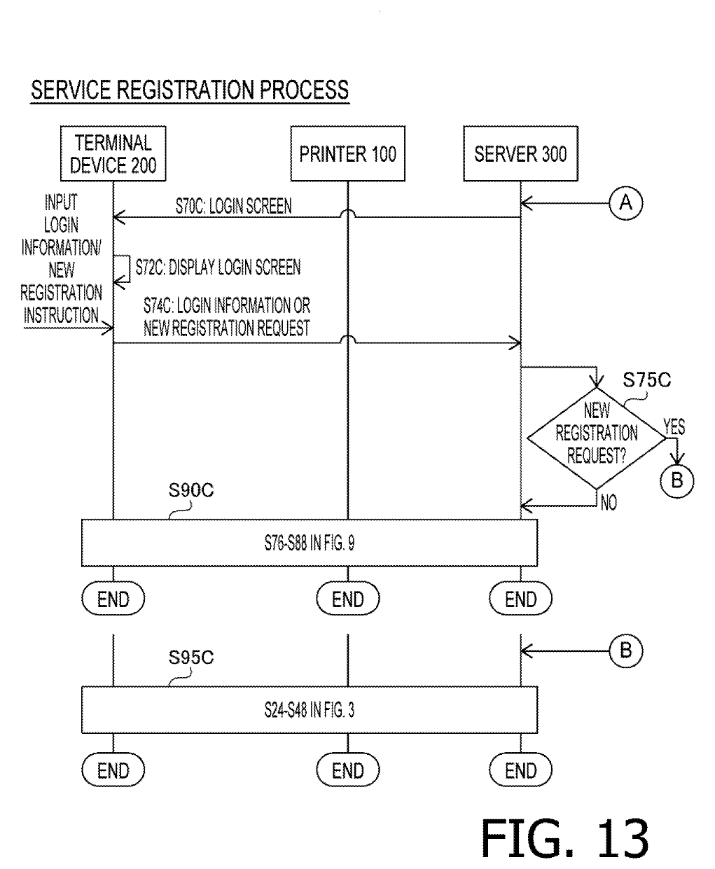

In addition, the user registration process of the modification of the embodiment partially differs from a user registration process of the embodiment shown in FIGS. 3 and 9. FIG. 13 is a sequence diagram of the service registration process of the modification. In a state in which the printer 100 is unregistered, the user registration process of the modification executes the same user registration process shown in FIG. 3. In the service registration process of the modification, processes in a state in which a target device, for example, the printer 100, is registered—in other words, a state in which at least one user is registered in association with the printer 100—differ from that of the first embodiment. Specifically, in the service registration process of the modification, processes of FIG. 13 are executed instead of the processes of FIG. 9.

In the modification, when, at S22 of FIG. 3, the server 300 determines that the printer 100, which is the target device, is registered (S22: YES), the process proceeds to S70C of FIG. 13.

At S70C, the server 300 transmits data of a login screen W5C, which is different from a login screen W5 of the first embodiment, to the terminal device 200. When the terminal device 200 receives the data of the login screen W5C, the terminal device 200 displays, at S72C, the login screen W5C on the display 240 using the data.

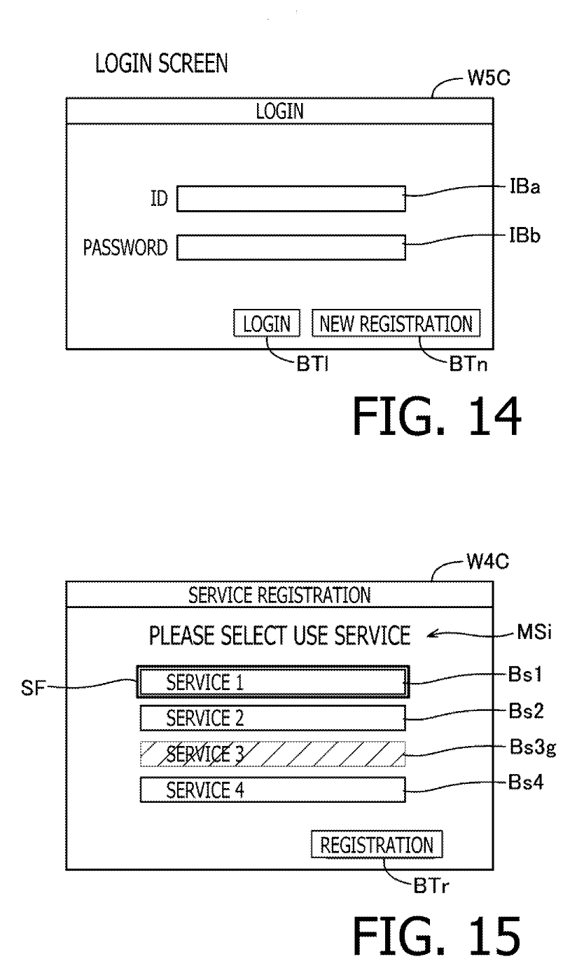

FIG. 14 illustrates an example of the login screen W5C of the modification. The login screen W5C of FIG. 14 includes, similarly to the login screen W5 of FIG. 10, input fields IBa and IBb and a login button BTl. The login screen W5C of FIG. 14 further includes a new registration button BTn. The new registration button BTn is an input element for inputting a new registration instruction to additionally register a new user to be associated with a target device, for example, the printer 100.

In the modification, when the printer 100 is registered in association with at least one user, the service registration process subsequently executed assumes the following two cases. A first case is a case in which, similarly to the first embodiment, an already registered user A additionally registers a new use service. A second case is a case in which a user B different from the already registered user A is newly registered in association with the printer 100.

In the first case, the already registered user A inputs login information into the input fields IBa and IBb of the login screen W5C and presses the login button BTl. In this case, at S74C, the terminal device 200 transmits to the server 300 the login information input on the login screen W5C, similarly to S74 of FIG. 9.

In the second case, a user B different from the already registered user A presses the new registration button BTn. In this case, at S74C, the terminal device 200 transmits a new registration request to the server 300.

When the server 300 receives the login information or the new registration request, the server 300 determines, at S75C, whether received data are the login information or the new registration request. When the server 300 receives the login information (S75C: NO), the server 300 executes, at S90C, the processes of S76-S88 of FIG. 8. That is, in this case, it is possible to newly register, in association with the already registered user A, an unregistered service as a new use service.

When the server 300 receives a new registration request (S75C: YES), the server 300 executes, at S95C, the processing of S24-S48 in FIG. 3. That is, in this case, after a user B different from the already registered user A is registered in association with the printer 100 (S32 of FIG. 3), a use service can be registered in association with the user B (S45 of FIG. 3).

Here, a service registration screen W4C displayed in the modification will be explained. FIG. 15 is a diagram illustrating an example of the service registration screen W4C of the modification. The service registration screen W4C of FIG. 15 can be displayed, for example, at S80 of FIG. 9 during the process at S90C in FIG. 13, or at S42 of FIG. 3 during the process at S95C in FIG. 13.

The service registration screen W4C of FIG. 15 includes a message MSi that prompts selection of a use service, a plurality of service selection buttons Bs1, Bs2, Bs3g, and Bs4, and a registration button BTr. The plurality of service selection buttons Bs1, Bs2, Bs3g, and Bs4 are input elements for inputting a selection instruction to select a use service from among multiple services 1-4.

At the time when the service registration screen W4C is displayed, in the modification as well, the services 1-4 include the first type services that can be newly registered and the second type services that cannot be newly registered. For example, in the modification, as shown in the service attribute table ST of FIG. 12, duplicate registration is permitted for services 1 and 2. Accordingly, in the service registration process for the user B, if the user B himself or herself has not registered services 1 and 2, the user B can register services 1 and 2 even if other users have already registered them. Duplicate registration is not permitted for services 3 and 4. Therefore, in the service registration process for the user B, the user B can register services 3 and 4 only when all users including the user B are unregistered for services 3 and 4.

That is, the first type service that can be newly registered includes a service that is already registered, as use services, in association with the printer 100 and for which duplicate registration is permitted. The second type service that cannot be newly registered includes a service that are already registered, as use services, in association with the printer 100 and for which duplicate registration is not permitted.

For example, the service registration screen W4C of FIG. 15 is a service registration screen displayed when the user B (user ID “UID_B”) executes the service registration process in a state where the registration state of use services is as shown in a record RdC in the device table DTc of FIG. 12.

In the state shown by the record RdC, the services 1-4 are unregistered for the user B, and the services 1 and 4 are unregistered and the services 2 and 3 are registered for the user A. As shown in the service attribute table ST, duplicate registration is permitted for the service 2, whereas duplicate registration is not permitted for the service 3. Therefore, in this example, the services 1, 2, and 4 are the first type services that can be newly registered, and the service 3 is the second type service that cannot be newly registered.

Accordingly, the service registration screen W4C of FIG. 15 is configured to allow input of a selection instruction to select the services 1, 2, and 4 and to disallow input of a selection instruction to select the service 3. That is, on the service registration screen W4C of FIG. 15, a service selection button Bs3g for inputting a selection instruction to select the service 3 is grayed out, and a user cannot select the service 3. The other service selection buttons Bs1, Bs2, and Bs4 are buttons to which a selection frame SF can be added by pressing, and a user can select the services 1, 2, and 4.

According to the modification described above, the first type service that can be newly registered includes a service that are already registered as use services and for which duplicate registration by multiple users is permitted, and the second type service that cannot be newly registered includes a service that is already registered as use services and for which duplicate registration by multiple users is not permitted. As a result, the user registration can be performed flexibly according to, for example, characteristics of a service and an operation policy of the service. For example, regardless of how many users use the printer 100, it is preferable that the printing material such as ink or toner be managed for each printer 100. Therefore, it is preferable that duplicate registration for the printing material management service not be permitted. In addition, because fields of interest and tendencies of consumption behavior differ by user for an advertising distribution service, it may be preferable to distribute different advertisements to respective users. Therefore, duplicate registration for the advertising distribution service may be considered acceptable.

### C. Another modification

In the first embodiment described above, the serial number of the printer 100 is transmitted from the printer 100 to the terminal device 200 (S16 of FIG. 3) and is then transmitted from the terminal device 200 to the server 300 (S20 of FIG. 3). In contrast, in another modification of the embodiment according to aspects of the present disclosure, the serial number of the printer 100 is transmitted directly from the printer 100 to the server 300 without passing through the terminal device 200.

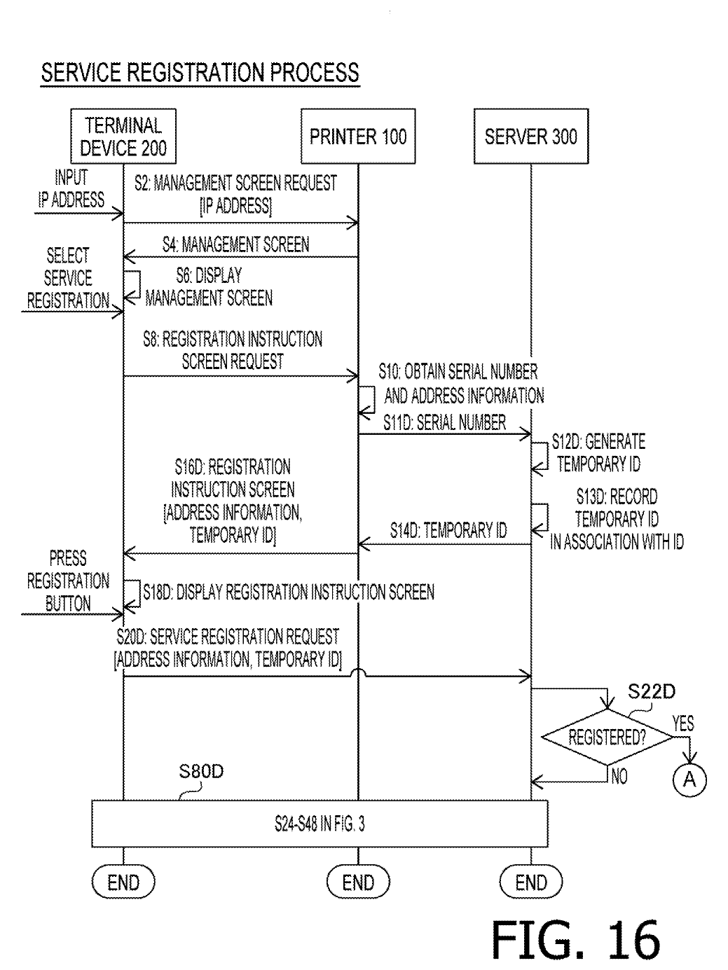

FIG. 16 is a sequence diagram of a service registration process of the other modification. The steps S2-S10 of FIG. 16 are the same as the steps S2-S10 of FIG. 3. When the printer 100 acquires its own serial number and address information of the server 300 from a database DBp at S10, the printer 100 transmits the serial number directly to the server 300 at S11D. Communication between the printer 100 and the server 300 is performed in accordance with a known protocol such as HTTP. Therefore, data transmitted from the printer 100 to the server 300 are transmitted as HTTP requests, and data transmitted from the server 300 to the printer 100 are transmitted as HTTP responses.

When the server 300 receives the serial number of the printer 100, the server 300 generates, at S12D, a temporary ID. The temporary ID is, for example, a randomly generated string or number. At S13D, the server 300 records, in a database DBs, the generated temporary ID in association with the serial number of the printer 100. At S14D, the server 300 transmits the generated temporary ID to the printer 100.

When the printer 100 receives the temporary ID, the printer 100 transmits, at S16D, data of a registration instruction screen W2 to the terminal device 200. The data of the registration instruction screen W2 include the temporary ID received from the server 300 and address information (e.g., URL) of the server 300. For example, the temporary ID is included in the data of the registration instruction screen W2 in a state in which the temporary ID is associated with a query parameter to the URL of the server 300.

When the terminal device 200 receives the data of the registration instruction screen W2, the terminal device 200 displays the registration instruction screen W2 (FIG. 5) on a display 240 using the data at S18D similarly to S18 of FIG. 3. As in the first embodiment, the user presses a registration instruction button BTs (FIG. 5) to input, to the terminal device 200, a registration instruction of a service. When the registration instruction is input to the terminal device 200, the terminal device 200 transmits, at S20D, a service registration request to the server 300 in accordance with the address information (URL) of the server 300. The service registration request includes the above described temporary ID and the address information (URL) of the server 300. Specifically, in HTML data of the registration instruction screen W2, the registration instruction button BTs is associated with the URL of the server 300 to which the temporary ID is associated with a query parameter. Therefore, when the registration instruction button BTs is pressed, an HTTP request including the URL as destination information is transmitted from the terminal device 200 to the server 300 as the service registration request.

When the server 300 receives the service registration request, the server 300 determines whether a printer 100 of a user requesting service registration is registered at S22D. Specifically, the server 300 acquires the temporary ID included in the service registration request, searches for the temporary ID in the database DBs, and acquires a serial number associated with the temporary ID in the database DBs. Thus, the server 300 can acquire the serial number of the printer 100 received at S11D. The server 300 determines whether the acquired serial number of the printer 100 is recorded in a device table DT (FIG. 2) stored in the database DBs. When the serial number is recorded in the device table DT, it is determined that the target device is registered, and when the serial number is not recorded in the device table DT, it is determined that the target device is unregistered.

Processes after S22D are the same as in the first embodiment. That is, in a case where the printer 100 is unregistered (S22D: NO), the server 300 executes the processes of S24-S48 of FIG. 3 at S80D. In a case where the printer 100 has been registered (S22D: YES), the server 300 executes the processes of S70-S88 of FIG. 9.

According to the other embodiment described above, the printer 100 transmits, to the terminal device 200 in response to a request from the terminal device 200 (S8 of FIG. 16), data of the registration instruction screen W2 (S16D of FIG. 16) and thereby causes the registration instruction screen W2 to be displayed on the display 240 of the terminal device 200 (S18D of FIG. 16). The data of the registration instruction screen W2 include address information indicating the location of the server 300. When transmitting the data of the registration instruction screen W2 to the terminal device 200, the printer 100 transmits the serial number of the printer 100 to the server 300 (S11D of FIG. 16). When the registration instruction is input to the registration instruction screen W2 displayed on the display 240 of the terminal device 200, the server 300 receives the service registration request transmitted from the terminal device 200 to the server 300 according to the address information (S20D of FIG. 16).

In response to receiving the service registration request (S20D of FIG. 16), the server 300 transmits data of the input screen W3 to the terminal device 200 (S80D of FIG. 16; S24 of FIG. 3) and thereby causes the input screen W3 to be displayed on the display 240 of the terminal device 200 (S80D of FIG. 16; S26 of FIG. 3). When the user information is input to the input screen W3 displayed on the display 240 of the terminal device 200 and received from the terminal device 200 (S80D of FIG. 16; S30 of FIG. 3), the server 300 stores the user information and the serial number in an associated manner (S80D of FIG. 16; S32 of FIG. 3; records Ru and Rd of FIG. 2), thereby registering the user and the printer 100 in association with each other. As a result, the server can register the user and the printer in association with each other. In addition, since the serial number of the printer 100 is transmitted from the printer 100 to the server 300, the user does not need to input the serial number of the printer 100 to the terminal device 200. Accordingly, as in the first embodiment, a burden on the user in the service registration process can be reduced.

### D. Other Modifications

(1) The processes after service registration (FIG. 8) in the embodiments described above are merely examples and are not limited to the processes of FIG. 8. For example, processes different from that of FIG. 8 may be executed depending on a type of a registered service.

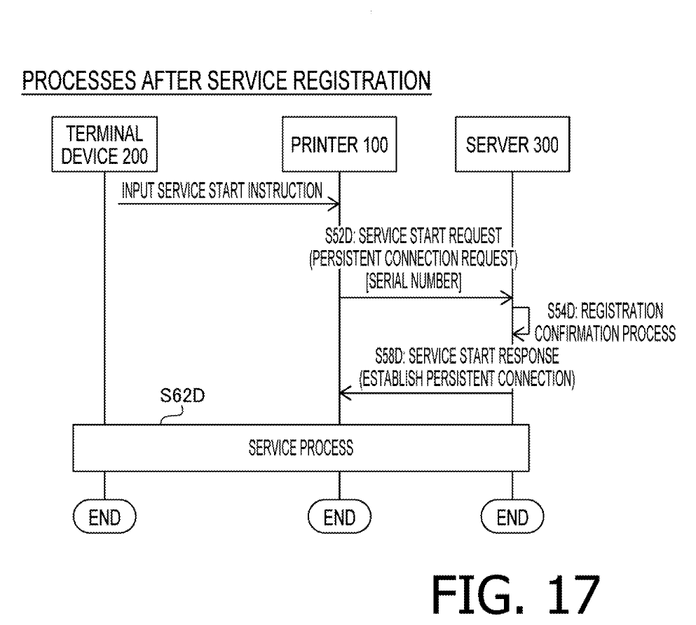

FIG. 17 is a flowchart of processes after service registration according to a modification of the embodiment. After the service registration process, the user operates the operation unit 150 of the printer 100 to input to the printer 100 a start instruction for the registered use service, for example, an advertising distribution service.

When a start instruction for the advertising distribution service is input, the printer 100 transmits, at S52D, a service start request including the serial number of the printer 100 to the server 300. Thus, in this modification, unlike the processes of FIG. 8, a device ID for the service is not generated.

When the server 300 receives the service start request, the server 300 executes a registration confirmation process at S54D. This registration confirmation process is the same as the process at S54 of FIG. 8. That is, the server 300 searches, in the device table DT, for the record Rd that includes the serial number included in the service start request and, with reference to the record Rd, confirms whether a service that is the target of the service start request (e.g., an advertising distribution service) is registered as a use service.

In a case where the service that is the target is unregistered, the server 300, for example, transmits an unregistered notification to the printer 100 and interrupts the processing of FIG. 17 (not illustrated). In a case where the target service has been registered, the server 300 establishes, at S58D, a persistent connection between the printer 100 and the server 300 by transmitting a service start response. That is, in this modification, the service start request at S52D is transmitted, in accordance with a particular protocol, as a persistent connection request that requests establishment of a persistent connection to the server 300. The service start response at S58D is transmitted, in accordance with the predetermined particular, as a response (i.e., a persistent connection response) to the persistent connection request. As the protocol for the persistent connection, for example, protocols called MQTT (Message Queuing Telemetry Transport) and XMPP (eXtensible Messaging and Presence Protocol) may be employed.

When the processes of S54D-S58D establishes the persistent connection between the printer 100 and the server 300, the printer 100 transitions to a state in which communication for providing the service can be performed with the server 300. Specifically, the printer 100 transitions to a state in which the server 300 can proactively transmit data such as print jobs. Note that, in this modification, unlike the processes of FIG. 8, transmission and storage of the service information to the printer 100 are not performed.

At S62D, using the persistent connection between the printer 100 and the server 300, the service process for providing a use service to a user is executed (S62 of FIG. 8). For example, when the use service is the advertising distribution service, at a timing for distributing advertisements, the server 300 transmits, using the persistent connection, a print job that causes an advertisement image to be printed to the printer 100, and the printer 100 prints the advertisement image in accordance with the print job.

When the persistent connection between the printer 100 and the server 300 is disconnected due to, for example, power to the printer 100 being cut off, when the persistent connection becomes able to be established (e.g., when power to the printer 100 is turned on), the printer 100 transmits to the server 300 the service start request (that is, the persistent connection request). As a result, the above described S52D-S58D are executed again, the persistent connection is established, and the system returns to a state in which the service process at S62D can be executed.

As an alternative to establishing a persistent connection, the printer 100 may, after transmitting the service start request, periodically transmit polling signals to the server 300. Even in this case, the server 300 can provide a use service such as the advertising distribution service by transmitting a print job in response to a polling signal.

(2) In the modification described above, when the printer 100 transmits data of the registration instruction screen W2 to the terminal device 200 (S16D of FIG. 16), the printer 100 has previously transmitted the serial number of the printer 100 to the server 300 (S11D of FIG. 16). Alternatively, when the printer 100 transmits the data of the registration instruction screen W2 to the terminal device 200, the printer 100 may transmit the serial number of the printer 100 to the server 300 after transmitting the data of the registration instruction screen W2 to the terminal device 200. For example, the printer 100 may generate a temporary ID, include the temporary ID in the data of the registration instruction screen W2, and transmit the data to the terminal device 200. Thereafter, the printer 100 may transmit the temporary ID and the serial number to the server 300. The server 300 need only store, the database DBs, the temporary ID and the serial number received from the printer 100 in association with each other.

(3) In the embodiments described above, after the user and the device are registered (S32 of FIG. 3), the processes for registering the use service from among multiple services (S38-S45 of FIG. 3) are executed. For example, when there is only one type of use service, the one type of use service may be set available at the time when the user and the device are registered, and the processes for registering the use service (S38-S45 of FIG. 3) may be omitted.

(4) In the service registration process of FIG. 3, when it is determined at S22 of FIG. 3 that the device is already registered (YES at S22 of FIG. 3), data of the login screen W5 are transmitted at S70 of FIG. 9 from the server 300 to the terminal device 200, and the login screen W5 is displayed on the terminal device 200 (S72 of FIG. 9). Alternatively, when the device is already registered, the service registration process may be terminated. In this case, for example, the user may newly input, into the web browser of the terminal device 200, a URL for login and access the login screen.

(5) A configuration for allowing input of the selection instruction to select the first type service that can be newly registered and disallowing input of the selection instruction to select the second type service that cannot be newly registered on the service registration screens W4b and W4C is not limited to a configuration in which the service selection buttons are grayed out. For example, on the service registration screen, it may be configured to display only selection buttons for the first type services and not to display selection buttons for the second type services.

(6) A service registration screen may be configured to allow input of both the instruction to select the first type service that can be newly registered and the instruction to select the second type service that cannot be newly registered. In this case, the server 300 may receive, from the terminal device 200, the service registration request that attempts to register, as the use service, the second type service that cannot be newly registered. In such a case, the server 300 may notify the terminal device 200 that the service is unregistrable and cause the terminal device 200 to transmit, again, the service registration request for registering another service.

(7) The first type service that can be newly registered and the second type service that cannot be newly registered in the above embodiments are merely examples and are not limiting. For example, the first type service that can be newly registered and the second type services that cannot be newly registered may be classified according to a type of the printer. For instance, when the printer 100 is a monochrome printer capable of printing monochrome images but incapable of printing color images, a content service that distributes data of color content images is classified as the second type service that cannot be newly registered.

(8) In the input screen W3 of FIG. 6, although the serial number of the printer 100 is displayed in the display field NB1, the display of the serial number may be omitted.

(9) In the above embodiments, the server 300 provides the services 1-4. Alternatively, a server different from the server 300 may provide the services 1-4, and the server 300 may be only a server that manages user registration for the services and registration of use services. In this case, for example, the processes after service registration shown in FIGS. 8 and 17 may be executed between the printer 100 and the server different from the server 300 that provides the services.

(10) In the above embodiments, the service registration process is implemented by the single server 300. Alternatively, the process may be implemented by two or more servers capable of communicating with each other with roles divided. For example, a first server that communicates with the terminal device 200 and provides various the screens W1-W5 to the terminal device 200, and a second server that manages registration information such as the user table UT and the device table DT, may cooperate to implement the service registration process.

(11) In the above embodiments, part of a configuration implemented by hardware may be replaced with software, and conversely, part or all of the configuration implemented by software may be replaced with hardware.

(12) When part or all of functions of the embodiment according to aspects of the present disclosure are implemented by a computer program, the program can be provided in a form stored in a computer readable recording medium (e.g., a non-transitory recording medium). The program can be used in a state stored in the same or a different recording medium e.g., (a computer readable recording medium) from that at the time of provision. The “computer readable recording medium” is not limited to a portable recording medium such as a memory card or a CD ROM, and may also include an internal storage device in a computer such as various ROMs and an external storage device connected to a computer such as a hard disk drive.

As described above, the present application has been explained based on embodiments and modifications. However, the embodiments according to aspects of the present disclosure described above are provided for facilitating understanding of the present application and are not intended to limit the present application. The present application may be changed and improved without departing from the spirit and scope of the application as set forth in the appended claims, and equivalents thereof are included in the present application.

What is claimed is:

1. A system comprising a printer and a server,
wherein the printer is configured to transmit, to a terminal device, data of a first screen including an input element for a user inputting a registration instruction in response to a request from the terminal device, thereby causing a display of the terminal device to display the first screen, the data of the first screen including printer identification information identifying the printer and address information indicating a location of the server, and
wherein the server is configured to:
when the registration instruction is input to the first screen displayed on the display of the terminal device, receive a registration request transmitted from the terminal device to the server in accordance with the address information, the registration request including the printer identification information;
in response to receiving the registration request, transmit, to the terminal device, data of a second screen including input elements for inputting user information, thereby causing the display of the terminal device to display the second screen, the second screen being a screen for registering, with the server, user information of a user that is not registered in association with the printer; and
when the user information input to the second screen is received from the terminal device, store the user information and the printer identification information included in the registration request in an associated manner, thereby registering the user and the printer in an associated manner.

2. A system comprising a printer and a server,
wherein the printer is configured to:
transmit, to a terminal device, data of a first screen including an input element for a user inputting a registration instruction in response to a request from the terminal device, thereby causing a display of the terminal device to display the first screen, the data of the first screen including address information indicating a location of the server; and
transmit printer identification information identifying the printer to the server when transmitting the data of the first screen to the terminal device,
wherein the server is configured to:
when the registration instruction is input to the first screen displayed on the display of the terminal device, receive a registration request transmitted from the terminal device to the server in accordance with the address information;
in response to receiving the registration request, transmit, to the terminal device, data of a second screen including input elements for inputting user information, thereby causing the display of the terminal device to display the second screen, the second screen being a screen for registering, with the server, user information of a user that is not registered in association with the printer; and
when the user information input to the second screen is received from the terminal device, store the user information and the printer identification information transmitted from the printer in an associated manner, thereby registering the user and the printer in an associated manner.

3. The system according to claim 1,
wherein the server is further configured to:
when receiving the registration request, determine, based on the printer identification information, whether the printer has been registered or unregistered; and
when the printer has been registered, the server transmits, to the terminal device, data of a third screen including input elements for entering login information in response to receiving the registration request, thereby causing the display of the terminal device to display the third screen, and
when the printer has been unregistered, the server transmits, to the terminal device, the data of the second screen.

4. The system according to claim 1,
wherein the server is further configured to:
after the user and the printer are registered, transmit, to the terminal device, data of a fourth screen including an input element for inputting a selection instruction to select one or more services from among a plurality of services used with the printer, thereby causing the display of the terminal device to display the fourth screen, and
when receiving, from the terminal device, information indicating the service selected by the selection instruction input in the fourth screen, store the information indicating the selected service in association with the user information and the printer identification information, thereby registering a use service to be used by the user with the printer.

5. The system according to claim 4,
wherein the plurality of services includes first type services that are registrable and second type services that are not registrable at a time when the fourth screen is displayed, and
wherein the fourth screen is configured to receive input of a selection instruction to select the first type service and not to receive input of a selection instruction to select the second type service.

6. The system according to claim 5,
wherein the first type service include a service which is unregistered as the use service.

7. The system according to claim 5,
wherein the second type service include a service which is already registered as the use service.

8. The system according to claim 5,
wherein the server is configured to register a plurality of users in association with a single printer,
wherein the first type service includes a service which is already registered as the use service and for which duplicate registration by a plurality of users is permitted, and
wherein the second type service includes a service which is already registered as the use service and for which duplicate registration by a plurality of users is not permitted.

9. The system according to claim 1,
wherein the second screen includes a field in which the printer identification information is displayed.

10. The system according to claim 1,
wherein the printer is configured to transmit a start request for a particular service to the server after the user and the printer are registered in association with each other, and
wherein the server is configured to transmit, in response to receiving the start request, a particular response to the printer, thereby causing the printer to transition to a state in which communication for the particular service with the server can be performed.

11. A method for performing user registration using a printer and a server, the method comprising:
transmitting, from the printer to a terminal device, data of a first screen including input elements for inputting a registration instruction in response to a request from the terminal device, thereby causing a display of the terminal device to display the first screen, the data of the first screen including printer identification information identifying the printer and address information indicating a location of the server;
transmitting a registration request from the terminal device to the server in accordance with the address information when the registration instruction is input to the first screen displayed on the display of the terminal device, the registration request including the printer identification information;
transmitting, from the server to the terminal device, data of a second screen including input elements for inputting user information in response to receiving the registration request, thereby causing the display of the terminal device to display the second screen, the second screen being a screen for registering, with the server, user information of a user that is not registered in association with the printer;
transmitting, from the terminal device to the server, the user information input to the second screen; and
storing, by the server, the user information and the printer identification information included in the registration request in an associated manner, thereby registering a user and the printer in an associated manner.

12. A method for performing user registration using a printer and a server, the method comprising:
transmitting, from the printer to the terminal device, data of a first screen including input elements for inputting a registration instruction in response to a request from a terminal device, thereby causing a display of the terminal device to display the first screen, the data of the first screen including address information indicating a location of the server;
transmitting, from the printer to the server, the printer identification information when transmitting the data of the first screen to the terminal device;
transmitting a registration request from the terminal device to the server in accordance with the address information, when the registration instruction is input to the first screen displayed on the display of the terminal device;
transmitting, from the server to the terminal device, data of a second screen including input elements for inputting user information in response to receiving the registration request, thereby causing the display of the terminal device to display the second screen, the second screen being a screen for registering, with the server, user information of a user that is not registered in association with the printer;
receiving, at the server, the user information input to the second screen from the terminal device; and
storing, by the server, the user information and the printer identification information transmitted from the printer in an associated manner, thereby registering a user and the printer in an associated manner.
